(19) United States
(12) Patent Application Publication
(10) Pub. No.: US 2022/0197171 A1
(43) Pub. Date: Jun. 23, 2022

(54) TONER HAVING EXTRA PARTICULAR ADDITIVES

(71) Applicant: LEXMARK INTERNATIONAL, INC., LEXINGTON, KY (US)

(72) Inventors: KASTURI RANGAN SRINIVASAN, LONGMONT, CO (US); RUDOLPH WAYNE HROBSKY, PLATTEVILLE, CO (US); JAMES CRAIG MINOR, NIWOT, CO (US); DINESH TYAGI, MEAD, CO (US)

(21) Appl. No.: 17/202,586

(22) Filed: Mar. 16, 2021

Related U.S. Application Data
(63) Continuation of application No. 17/130,481, filed on Dec. 22, 2020.

(51) Int. Cl. G03G 9/097; G03G 9/08; G03G 9/087

(52) U.S. Cl. CPC G03G 9/09725; G03G 9/09716; G03G 9/0819; G03G 9/0812; G03G 9/08755; G03G 9/09791

(57) ABSTRACT

A toner composition having improved toner usage efficiency, wherein toner particles having an average size range of 1-25 μm may be mixed with an extra particulate additive package including a first small silica surface treated with both a silane and an aminosilane having a primary particle size of about 5 nm-20 nm, a second fumed silica having a primary particle size of 30 nm-60 nm, a third silica having a primary particle size of about 70 nm-120 nm, an electro-conductive titania having a primary particle size of 30 nm-60 nm and an acicular titania having a size of about 1.6 μm to 1.7 μm in length and about 130 nm in diameter. An alternative embodiment of the extra particulate additive package does not include a third silica having a primary particle size of about 70 nm-120 nm.

### CROSS REFERENCES TO RELATED APPLICATIONS

This application is a continuation application of U.S. patent application Ser. No. 17/130,481, filed Dec. 22, 2020, entitled “TONER HAVING EXTRA PARTICULAR ADDITIVES”.

### BACKGROUND

The present invention relates generally to an improved toner composition and method to make the same using specific types of silica as extra particulate additives wherein the toner formulation generates less toner waste, increases toner usage efficiency and significantly reduces toner consumption without impacting image quality and charge characteristics. One of the silicas used as an extra particulate additive in this inventive extra particulate additive package is preferably surface treated with a non-amine silane and an aminosilane. Additionally, this silane and aminosilane modified silica has a carbon content of no less than 3.5% by weight. This carbon content is achieved by surface treating this silane and aminosilane modified silica.

### DESCRIPTION

Toner may be utilized in image forming devices, such as printers, copiers and/or fax machines to form images upon a sheet of media. The image forming apparatus may transfer the toner from a reservoir to the media via a developer system utilizing differential charges generated between the toner particles and the various components in the developer system. Control of flow properties may be achieved by dry toner surface modification and the attachment or placement of fine particles, or extra-particulate additives on the surface of the particles. Moreover, decrease in overall toner usage by the consumer is an important concern to the consumer in terms of a cost and environmental standpoint.

### SUMMARY OF THE INVENTION

An aspect of the present disclosure relates to a toner composition which may used in an electrophotographic printer or printer cartridge. This toner formulation generates less toner waste, increases toner usage efficiency and significantly reduces toner consumption without impacting image quality and charge characteristics. This improvement is accomplished by finishing the fused toner particle with a unique set of extra particulate additives (EPAs′).

The toner composition comprises toner particles having an average size in the range of 1-25 μm that may be mixed with a specific mixture of silicas and titanias—namely a first small silica having a primary particle size of about 5 nm-20 nm, a second fumed silica having a primary particle size of 30 nm-60 nm, a third silica having a primary particle size of about 70 nm-120 nm, an electro-conductive titania having a primary particle size of 30 nm-60 nm and an acicular titania having a size of about 1.6 μm to 1.7 μm in length and about 130 nm in diameter. An alternative embodiment of the EPA package includes a first small silica having a primary particle size of about 5 nm-20 nm, a second fumed silica having a primary particle size of 30 nm-60 nm, a third silica having a primary particle size of about 70 nm-120 nm, and an acicular titania having a size of about 1.6 μm to 1.7 μm in length and about 130 nm in diameter. Importantly, the first small silica is surface treated with both a silane and an aminosilane. The silane can include hexamethyldisilazane, dichlorodimethylsilane, dimethyldiethoxysilane, cyclic silanes or long chain alkyl silanes. Moreover, this silane and an aminosilane surface treated small silica has a carbon content of preferably less than 3.5%. This unique set of EPAs on the toner particle leads to a reduction in toner consumption and a decrease in toner-to-cleaner or waste toner. This translates into the environmentally desirable need for less cartridge manufacturing, less toner waste, reductions in paper consumption as well as significant savings in terms of cost of printing per page. Moreover, toner consumption is reduced without affecting the overall print quality.

### DETAILED DESCRIPTION

It is to be understood that the invention is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

### BACKGROUND

Electrophotographic printers and cartridges typically use either a mechanically milled toner or a chemically prepared toner (‘CPT’). Chemically prepared toner can be a toner derived from using a suspension polymerization method, an emulsion agglomeration (‘EA’) method, or an aggregation method. Independent of the method of preparation, toner flow properties and print quality metrics can be suitably manipulated by use of extra particulate additives (EPA's) to the toner particle surface. EPAs help improve the toner flow behavior, lower or eliminate the tendency to brick or cake under high temperature and/or humidity, improve transfer of toner from a photoreceptor to paper or an image transfer member, transfer between an image transfer member and paper, or regulate the toner charge across various environments (ie, varying temperature and humidity) and improve print quality. Alternately, the base toner particle can be prepared with an entirely different process commonly known as conventional or milled toner.

Whereas most of the toner formulation is printed on a document, a small amount of toner is lost as waste. Hence there is a desire to minimize waste toner and therefore maximize the toner usage efficiency. Toner usage efficiency is described as the ratio of toner on a printed page to total toner used. Similarly, waste toner will be herein after referred to as “toner in the cleaner” or “toner-to-cleaner (TtC)”.

Several EPAs have been employed in the surface treatment of toner. These EPAs include various inorganic oxides such as silicon dioxide also known as silica, titanium dioxide also known as titania, aluminum oxide, and composite mixtures of titania, silica and/or alumina. Further metal soaps have also been used to improve the transfer efficiency of a toner.

Inorganic oxides may be obtained using a fuming process or a colloidal process. Fumed silica, also known as pyrogenic silica, is produced in a flame. This type of silica consists of microscopic droplets of amorphous silica fused into branched, chainlike, three-dimensional secondary particles which then agglomerate into tertiary particles. In a typical case, fumed silica is produced by pyrolysis of silicon tetrachloride.

Inorganic oxides such as silica, titania, alumina etc., can vary in their primary particle size from about a 5 nm to several micrometers. Moreover, to achieve uniform print quality across different type of environments, inorganic oxides are surface treated with various treatments such as organosilanes and silicone oil. The extent of surface treatment of the hydroxyl groups in an inorganic oxide can also be varied. In regards to the primary particle size of then silica, the toner flow can be significantly improved by use of smaller primary particle size silica, usually about 5 nm-20 nm in combination with a large primary particle size such as 40 nm-250 nm. This larger sized silica serves as a useful ‘spacer’. Spacers are effective in keeping individual toners apart and hence can improve the storage stability. Silicas with a primary particle size of about 100 nm have been used in CPT to be effective spacers. The large silica described as a spacer is typically prepared by a sol-gel or colloidal process. Whereas the medium size silica, about 30 nm-60 nm primary particle size help with toner flow, they are ineffective spacers, and the large silica while functioning as a spacer requires to be used at higher concentrations or levels to help with toner flow. Hence there is a need for a silica that can help both with toner flow and also act as a suitable spacer between surface treated toner particles.

Metal oxides such as alumina, silica, titania, zirconia, ceria, strontium titantate, etc. have been used as surface additives for toner. Many of these additives may be insulative, having a volume resistivity in the range of E⁷ to E¹⁶ ohm-cm. A conductive additive may be defined as semi-conductive materials, having a volume resistivity in the range of E⁻¹ (10⁻¹) to about E⁶ (10⁶) ohm-cm or conductive material having a volume resistivity in the range of E⁻¹ to E⁶, including all values and increments therein. The conductive additives may be present in the form of particles wherein a conductive or semi-conductive material itself forms the particle. The conductive particle may therefore include antimony doped tin oxide, antimony doped indium oxide, antimony doped indium-tin oxide, zinc oxide with or without metal doping, carbon black and selected metal oxides, etc. In addition, the conductive additives may include an insulative particle that may be coated or otherwise doped with a semi conductive or conductive material. For example, the conductive particle may utilize a relatively nonconductive or semi conductive silica, alumina, titania, zinc oxide, etc., which may then be coated with inorganic or organic substances. Such coating substance may include poor metal oxides such as antimony oxide, tin oxide, etc. As defined herein, poor metals may include, for example, gallium, indium, thallium, germanium, tin, lead, antimony, bismuth, polonium or combinations thereof. The conductive coating may therefore include antimony doped tin oxide, antimony doped indium oxide, antimony doped indium-tin oxide, etc. Further conductive coatings may include organic conducting polymers such as polyanilines, polypyrroles, polythiophenes, etc. The above referenced conductive additives may have a particle size in the range of about 5 nm to about 2000 nm, including all values and increments therein. In addition, the conductive particles may have various geometries and may be, for example, substantially spherical, acicular, flake or a combination of geometries. By substantially spherical, it may be understood to have a degree of circularity of greater than or equal to about 0.90. Particular exemplary conductive additives may include Sb₂O₅ doped SnO₂ coated titania, having a particle size in the range of 10 to 400 nm, including all values and increments therein. In addition, the additives may have a specific surface area in the range of 1-60 m²/g as measured by BET method. The coated titania may also be treated with a coupling agent. Such additives may be available from Ishihara Corporation USA (ISK) under the product numbers ET-300W, ET-600W, ET-500W; as well as from Titan KKK under the product name EC-300T.

The inventors have surprisingly discovered that the use of a small 5 nm-20 nm silica that is surface treated with a mixture of a non-amine based silane and an aminosilane as a surface additive on a conventionally milled or a chemically processed toner generates a toner formulation having less toner waste, increases toner usage efficiency and significantly reduces toner consumption without impacting image quality and charge characteristics. In addition to the improvement in toner usage efficiency and/or reducing toner waste, this non-amine based silane and an aminosilane modified small silica also helps in mitigating high toner mass flow in low humidity environments. Importantly, the reduction in the high toner mass flow at the low humidity environments results in improving print uniformity. Although not well understood, the print quality defect associated with high toner mass flow is most evident in partially filled solid areas where the desired print is lighter tone achieved with even spaced pels. The toner on the developer roll may present a furrowed appearance to the development zone which is then imaged on the lightly toned image. The defect is then manifested as light streaks on the otherwise uniform dark or grey image.

The present invention is directed at a toner formulation which generates less toner waste, increases toner usage efficiency and significantly reduces toner consumption without impacting image quality and charge characteristics. This improved toner formulation comprises toner particles having an average size in the range of 1-25 μm that may be mixed with a specific mixture of silicas and titanias—namely a first small silica having a primary particle size of about 5 nm-20 nm, a second fumed silica having a primary particle size of 30 nm-60 nm, a third silica having a primary particle size of about 70 nm-120 nm, an electro-conductive titania having a primary particle size of 30 nm-60 nm and an acicular titania having a size of about 1.6 to 1.7 μm in length and about 130 nm in diameter. An alternative embodiment of the EPA package includes a first small silica having a primary particle size of about 5 nm-20 nm, a second fumed silica having a primary particle size of 30 nm-60 nm, a third silica having a primary particle size of about 70 nm-120 nm, and an acicular titania having a size of about 1.6 μm to 1.7 μm in length and about 130 nm in diameter. Importantly, the first small silica is surface treated with both a silane and an aminosilane. The silane can include hexamethyldisilazane, dichlorodimethylsilane, dimethyldiethoxysilane, cyclic silanes or long chain alkyl silanes. Moreover, this silane and an aminosilane surface treated small silica has a carbon content of preferably less than 3.5%. The toner particle may be prepared by a milled or conventional process or a chemical process, such as suspension polymerization or emulsion aggregation.

In one example, the toner particles may be prepared via an emulsion aggregation procedure, which generally provides resin, colorant and other additives. More specifically, the toner particles may be prepared via the steps of initially preparing a polymer latex from a set of polyester resins that are in a polymer resin emulsion form. The polymer latex so formed may be prepared at a desired molecular weight distribution (MWD=Mw/Mn) and may, for example, contain both relatively low and relatively high molecular weight fractions to thereby provide a relatively bimodal distribution of molecular weights. Pigments may then be milled in water along with a surfactant that has the same ionic charge as that employed for the polymer latex. Release agent (e.g., a wax or mixture of waxes) including olefin type waxes such as polyethylene may also be prepared in the presence of a surfactant that assumes the same ionic charge as the surfactant employed in the polymer latex. Optionally, one may include a charge control agent.

The polymer resin emulsion, pigment dispersion and wax dispersion may then be mixed and the pH adjusted to cause flocculation. For example, in the case of anionic surfactants, acid may be added to adjust pH to neutrality. Flocculation therefore may result in the formation of a gel where an aggregated mixture may be formed with particles of about 1-2 μm in size.

Such mixture may then be heated to cause a drop in viscosity and the gel may collapse and relative loose (larger) aggregates, from about 1-25 μm, may be formed, including all values and ranges therein. For example, the aggregates may have a particle size between 3 μm to about 15 μm, or between about 4 μm to about 10 μm. In addition, the process may be configured such that at least about 80-99% of the particles fall within such size ranges, including all values and increments therein. Base may then be added to increase the pH and reionize the surfactant or one may add additional anionic surfactants. The temperature may then be raised to bring about coalescence of the particles. Coalescence is referenced to fusion of all components. The toner may then be removed from the solution, washed and dried.

It is also contemplated herein that the toner particles may be prepared by a number of other methods including mechanical methods, where a binder resin is provided, melted and combined with a wax, colorant and other optional additives. The product may then be solidified, ground and screened to provide toner particles of a given size or size range.

The resulting toner may have an average particle size in the range of 1 μm to 25μm. The toner may then be treated with a blend of extra particulate agents, including hydrophobic fumed alumina, hydrophobic fumed small silica sized less than 20 nm, medium silica sized 40 nm to 50 nm, large fumed silica sized 70 nm to 80 nm, and titania. Treatment using the extra particulate agents may occur in one or more steps, wherein the given agents may be added in one or more steps.

Conventional toner preparation consists of melt mixing a thermoplastic resin or resin blend with multiple additives, followed by crushing, grinding and classifying the resin based mixture to the desired particle size. The resin(s) (preferably polyester) are first mixed in a dry state with the desired additives such as pigments or colorants, waxes, charge control agents and other materials. The resin additive mixture is melt processed with a kneader or extruder with the objective of dispersing the additives in a uniform manner. After melt mixing, the cooled resin composite is typically crushed and milled or attrited (commonly in a fluidized air mill) to the desired particle size. It is common to concurrently classify the milled toner particles to remove the smaller or fine particles. The final step of toner preparation is the addition of EPAs in the manner like that employed in making CPT.

Referring again to the extra-particulate additives that may be used herein, small silica may be understood as silica (SiO₂) having an average primary particle size in the range of 2 nm to 20 nm, or between 5 nm to 20 nm (largest cross-sectional linear dimension) prior to any after treatment, including all values and increments therein. The small silica is preferably surface treated chemically with a mixture of non-amine silane and Amino silane. It is also preferred that the surface treatment on the small silica is about 2%-7% by weight of Carbon content and more preferably from 3%-4%. The amount of surface treatment thus achieved can render a silica more hydrophobic, and effective in achieving the desired tribocharge. The small silica may be present in the toner formulation as an extra particulate additive in the range of 0.01% to 3.0% by weight of the toner composition, such as 0.1% to 1.0% by weight, including all values and increments therein. In addition, this small silica may be treated with hexamethyldisilazane. An exemplary small silica is available from Evonik Corporation under the tradename AEROSIL. Modified small silicas as discussed in the invention are termed as “SS”.

Medium sized fumed silica may be understood as silica having a primary particle size in the range of 30 nm to 60 nm, or between 40 nm to 50 nm, prior to any after treatment, including all values and increments therein. Primary particle size may be understood as the largest linear dimension through a particle volume. The medium sized silica may be present in the toner formulation as an extra particulate agent in the range of 0.1% to 2.0% by weight of the toner composition, including all values and increments in the range of 0.1% to 2.0% by weight. The medium sized silicas may also be treated with surface additives that may impart different hydrophobic characteristics or different charges to the silica. For example, the silica may be treated with hexamethyldisilazane (silane), polydimethylsiloxane (silicone oil), etc. Exemplary silicas may be available from Evonik Corporation under the tradename AEROSIL and product numbers RX-50 or RY-50.

Large silica may be understood as silica having a primary particle size in the range of 60 nm to 120 nm, or preferably between 70 nm to 110 nm, prior to any after treatment, including all values and increments therein. The large colloidal silica may be present in the toner formulation as an extra particulate agent in the range of 0.1% to 2 wt %, for example in the range of 0.25 wt % to 1.5 wt % of the toner composition. The large fumed silica may also be treated with surface additives that may impart different hydrophobic characteristics or different charges to the silica. For example, the large fumed silica may be treated with hexamethyldisilazane, polydimethylsiloxane, dimethyldichlorosilane, and combinations thereof, wherein the treatment may be present in the range of 1 wt % to 10 wt % of the silica. The weight % of a polydimethylsiloxane on the silica is about 0.5 wt % to about 5 wt %, and more preferably from about 0.5 wt % to about 4 wt %. Exemplary fumed silicas may be available from Evonik Corporation under the trade name VPRY40S or VPRX40S.

In addition, titania (titanium-oxygen compounds such as titanium dioxide) may be added to the toner composition as an extra particulate additive. The titania may be a combination of an electro-conductive titania with a primary particle size of about 30 nm-40 nm, and an acicular titania mean particle length in the range of 0.1 μm to 3.0 μm, such as 0.5 μm-2.0 μm and a mean particle diameter in the range of 0.01 μm to 0.2 μm, such as 0.13 μm. The titania may be present in the formulation in the range of about 0.01% to 2.0% by weight by weight of the toner formulation, and preferably such as 0.1% to 1.5%. The acicular titania may include a surface treatment, such as aluminum oxide. An example of acicular titania contemplated herein may include FTL-110 available from ISK USA. An example of an electro-conductive titania contemplated herein may include ET-300W available from ISK USA. Other contemplated titanias may include those available from DuPont; Kemira of Finland under the product designation Kemira RODI or RDI-S; or Huntsman Pigments of Texas under the product name TIOXIDE R-XL.

The disclosed method to make the toner of the present invention operates to provide a finishing to toner particles, as more specifically described below. Such finishing may rely upon what may be described as a device for mixing, cooling and/or heating the particles which is available from Hosokawa Micron BV and is sold under the trade name “CYCLOMIX.” Such device may be understood as a conical device having a cover part and a vertical axis which device narrows in a downward direction. The device may include a rotor attached to a mixing paddle that may also be conical in shape and may include a series of spaced, increasingly wider blades extending to the inside surface of the cone that may serve to agitate the contents as they are rotated. Shear may be generated at the region between the edge of the blades and the device wall. Centrifugal forces may therefore urge product towards the device wall and the shape of the device may then urge an upward movement of product. The cover part may then urge the products toward the center and then downward, thereby providing a feature of recirculation.

The device as a mechanically sealed device may operate without an active air stream, and may therefore define a closed system. Such closed system may therefore provide relatively vigorous mixing and the device may also be configured with a heating/cooling jacket, which allows for the contents to be heated in a controlled manner, and in particular, temperature control at that location between the edge of the blades and the device wall. The device may also include an internal temperature probe so that the actual temperature of the contents can be monitored.

For example, conventional toner or chemically prepared toner (CPT) may be combined with one or more extra particulate additives and placed in the above referenced conical mixing vessel. The temperature of the vessel may then be controlled such that the toner polymer resins are not exposed to a corresponding glass transition temperature or Tg which could lead to some undesirable adhesion between the polymer resins prior to mixing and/or coating with the EPA material. Accordingly, the heating/cooling jacket may be set to a temperature of less than or equal to the Tg of the polymer resins in the toner, and preferably to a cooling temperature of less than or equal to about 25° C.

The conical mixing device with such temperature control may then be operated wherein the rotor of the mixing device may preferably be configured to mix in a multiple stage sequence, wherein each stage may be defined by a selected rotor rpm value (RPM) and time (T). Such multiple stage sequence may be particularly useful in the event that one may desire to provide some initial break-up of toner agglomerates. In addition, such initial first stage of mixing may be controlled in time, such that the conical mixer operates at such rpm values for a period of less than or equal to about 60 seconds, including all values and increments therein. Then, in a second stage of mixing, the rpm value may be set higher than the rpm value of the first stage, e.g., at an rpm value greater than about 500 rpm. Furthermore, the time for mixing in the second stage may be greater than about 60 seconds, and more preferably, about 60-180 seconds, including all values and increments therein. For example, the second stage may therefore include mixing at a value of about 1300-1350 rpm for a period of about 90 seconds. Following the above mentioned blending the toner with surface additives can be subjected to a screening step or a classifying step to remove any undesired large agglomerates or particles. It may be appreciated that following the screening or classifying step the toner can be placed in the conical mixer and further blended to achieve better adhesion of the surface additives to the toner surface.

It can therefore be appreciated that with respect to the mixing that may take place in the present invention, as applied to mixing EPA with toner, such mixing may efficiently take place in multiple stages in a conical mixing device, wherein EPA may be added in a first stage wherein the breaking of aggregates may be accomplished, followed by screening, and then additional EPA added before the toner is cooled. In addition, the temperature of the mixing process may again be controlled within such multiple staged mixing protocol such that the heating/cooling jacket and/or the polymer within the toner (as measured by an internal temperature probe) is maintained below its glass transition temperature (Tg).

It has been found that the mixing of toner particle with extra particulate additive in the conical mixing device according to the above provides a relatively more uniform surface distribution of EPA.

The extra particulate additives may serve a variety of functions, such as to modify or moderate toner charge, increase toner abrasive properties, influence the ability/tendency of the toner to deposit on surfaces, improve toner cohesion, or eliminate moisture-induced tribo-excursions. The extra particulate additives may therefore be understood to be a solid particle of any particular shape. Such particles may be of micron or submicron size and may have a relatively high surface area. The extra particulate additives may be organic or inorganic in nature. For example, the additives may include a mixture of two inorganic materials of different particle size, such as a mixture of differently sized fumed silica. The relatively small sized particles may provide a cohesive ability, e.g. ability to improve powder flow of the toner. The relatively larger sized particles may provide the ability to reduce relatively high shear contact events during the image forming process, such as undesirable toner deposition (filming).

The small and large silica discussed in this invention are designated as follows:

TABLE 1

| Surface | | Primary | Surface | |
|---|---|---|---|---|
| Additive | | Particle | Area | |
| ID | Surface Treatment | size | (BET, m2/g) | % C |
| Aerosil | Hexamethyldisilazane | 7 nm | 250-350 | 2.0-3.0 |
| R812 | | | | |
| Aerosil | Hexamethyldisilazane/ | 12 nm | ~150 | ~3.0 |
| R504 | Aminopropylsilane | | | |
| Aerosil | Hexamethyldisilazane/ | 12 nm | ~140 | <3.0 |
| RA200HS | Aminopropylsilane | | | |
| SS-1 | Hexamethyldisilazane/ | 12 nm | ~213 | 3.6 |
| | Aminopropylsilane | | | |
| SS-2 | Hexamethyldisilazane/ | 12 nm | ~224 | 3.1 |
| | Aminopropylsilane | | | |
| SS-3 | Hexamethyldisilazane/ | 12 nm | ~228 | 2.9 |
| | Aminopropylsilane | | | |
| H30TA | Polydimethylsiloxane/ | 8 nm | ~300 | 7 |
| | Aminopropylsilane | | | |
| H13TA | Polydimethylsiloxane/ | 20 nm | ~125 | 4 |
| | Aminopropylsilane | | | |

The examples herein are for the purposes of illustration and are not intended to be exhaustive or to limit the invention to the formulations discussed herein. The toner used in this study corresponds to a chemically prepared polyester toner with a Tg of about 61° C. (1^{st} scan onset) and comprising of a resin with Mn˜4K, Mp˜40K and Mw˜120K, 7% Nipex 35 black pigment, was treated with a medium silica such as Aerosil RY50, a large silica such as VPRY40S, an electroconductive titania, an acicular titania and a small silica as identified in Table 1 above. Evaluation of the toner was carried out in a Lexmark CS725 printer in a high temperature/high humidity environment (78° F./80% RH) and results are shown below in Table 2.

TABLE 2
Performance of Different Small Silicas at a high temperature/high
humidity (78° F./80% RH) environment

| | Small | Q/M | DR M/A | | Toner |
|---|---|---|---|---|---|
| | silica | (μC/g) | (mg/cm²) | Avg. L* | Usage |
| Toner ID | Type | (0K/20K) | (0K/20K) | (0K/20K) | (mg/pg) |
| Comp. | R812 | −53.6/−42.2 | 0.19/0.40 | 7.1/11.2 | 14.6 |
| Example 1 | (% C: <3) | | | | |
| Comp | RA200HS | −51.4/−37.7 | 0.30/0.39 | 8.2/13.7 | 27.1 |
| Example 2 | (C % 3.0) | | | | |
| Comp | H30TA | −56.3/−50.2 | 0.28/0.35 | 7.5/9.5 | 50.2 |
| Example 3 | (% C: 7) | | | | |
| Comp | H13TA | −54.2/−44.3 | 0.29/0.41 | 8.5/15.7 | 33.6 |
| Example 4 | (% C: 4) | | | | |

Table 2 describes the evaluation of various small silicas that vary in their specific surface area from about 125-300 m²/g. Aerosil R812 is surface treated with only hexamethyldislazane. Aerosil R504 and Aerosil RA200HS have a hexamethyldislazane/aminopropylsilane surface treatment. H30TA and H13TA have a polydimethylsiloxane/aminopropylsilane surface treatment. It is relatively well known in the toner industry that the introduction of a silica surface treated with an Aminosilane lowers the tribocharge. Toner usage also tends to increase as the environmental humidity increases. Hence, it would be advantageous to evaluate the performance in a stress environment, i.e. evaluate small silica treated with various surface treatments in a hot/humid environment. As Table 2 illustrates, the charge is relatively similar across all of the tested small silicas. However, as the surface treatment is changed from a silane to a combination of silane/aminosilane or a polysiloxane/aminosilane, the toner usage per page increases significantly. It may also be noted that comparing Comp. Example 2 with Comp. Example 3, the toner usage is significantly increased when a small silica having a polysiloxane-aminosilane surface treatment (H30TA) is used. Hence, it would appear that the use of an aminosilane as a surface treatment agent on a small silica would be deleterious to toner performance.

As illustrated in Table 2, it is possible that the use of a small sized silica surface treated with an aminosilane may not be preferred. So as to gain a better understanding of the influence on overall toner performance of a small silica surface treated with an aminosilane, the inventors tested small sized silica that was surface treated with various levels of hexamethyldisilazane and aminosilane. Importantly, the inventors monitored the performance of the aminosilane by estimating the % Carbon content of the surface treated small silica. The toner identified in Table 3 corresponds to a chemically prepared polyester toner with a Tg of about 61° C. (1^{st} scan onset) and comprising of a resin with Mn˜4K, Mp˜40K and Mw˜120K, 7% Nipex 35 black pigment, was treated with a medium silica such as Aerosil RY50, a large silica such as VPRY40S, an electroconductive titania, an acicular titania and a small silica as identified in Table 1 above. Toners were evaluated in a modified Lexmark C792 printer (50 ppm), high temperature/high humidity) and results are shown below in Table 3:

TABLE 3
Performance of Small Silica type at a high temperature/high
humidity (78° F./80% RH) environment

| | Small | | | | Toner |
|---|---|---|---|---|---|
| | Silica | Q/M | DR M/A | Avg. L* | Usage/ |
| | Type | (μC/g) | (mg/cm²) | across | TTC |
| Toner ID | (% C) | (0K/20K) | (0K/20K) | page | (mg/pg) |
| Comp. | R812 | −45.9/−34.2 | 0.30/0.32 | 10.2-8.1 | 15.1/6.8 |
| Example 1 | (<3% C) | | | | |
| Example 1a | SS-1 | −44.5/−34.2 | 0.32/0.32 | 11.4-9.6 | 15.0/6.9 |
| | (3.6% C) | | | | |
| Example 1b | SS-2 | −46.9/−37.8 | 0.26/0.30 | 11.4-8.8 | 13.7/4.4 |
| | (3.1% C) | | | | |
| Example 1c | SS-3 | −51.8/−37.8 | 0.29/0.30 | 11.0-9.5 | 13.2/4.8 |
| | (2.9% C) | | | | |

As seen in Table 1, SS-1, SS-2 and SS-3 are similar to Aerosil RA200HS and only differ in the % C level. The small silicas SS-1 through SS-3 only differ on the amount of surface treatment and are all based on a mixture of hexamethyldisilazane and Aminosilane. The charge over unit mass on the developer roll shows a trend towards higher charge as the aminosilane content is lowered, and Example 1a, 1b, and 1c toners exhibit similar charge to Example 1 toner. Importantly, it may be noted that the lower % C containing silicas S-2 and S-3 require less toner to achieve a similar print darkness, and also generate less waste toner in the process. If one were to compare the performance of SS-1, -2 and -3, to silicas listed in Table 1, it would be obvious that silicas SS-1, SS-2 and SS-3 with the lower % C are significantly superior to silicas having a higher % C such as H30TA and H13TA that have either silane surface treatment or a mixture of aminosilane with either silane or polysiloxane.

U.S. Patent Publication No. 2017/0212438, assigned to the assignee of the present invention and its teaching incorporated herein by reference, describes the use of a large fumed silica in combination with an electroconductive titania and an acicular titania to achieve high toner usage efficiency. U.S. Pat. No. 7,695,882 to Broce et al., assigned to the assignee of the present invention and its teaching incorporated herein by reference, describe the use of an electroconductive titania to help overcome high toner mass flow on a developer roller. The use of the electroconductive titania is useful in achieving optimal print quality, and in combination with other surface additives, it can also help improve the toner usage efficiency. Surprisingly, the modified small silicas SS-1, SS2 and SS3 described herein above have shown to improve the toner usage efficiency in a similar manner. The inventors were then interested in seeing if the modified small silicas SS-1, SS-2 and SS-3 could replace the expensive electroconductive titania in an EPA package and achieve the required toner usage efficiency. The toners identified in Table 4 corresponds to a chemically prepared polyester toner with a Tg of about 61° C. (1^{st} scan onset) and comprising of a resin with Mn˜4K, Mp˜40K and Mw˜120K, 7% Nipex 35 black pigment, was treated with a medium silica such as Aerosil RY50, a large silica such as VPRY40S, an acicular titania and a small silica as identified in Table 1 above. Comp. Example 6, 6a, 6b, 6c and 7 toners were treated with the expensive electroconductive titania while Comp. Example 7a, 7b and 7c toners were not treated with the electroconductive titania. Toners in Table 4 were evaluated in a stress environment such as 78 F/80% RH, in a Lexmark C792 printer, to about 30000 pages.

TABLE 4
Printer test evaluation of toners having modified Small Silica
and as replacement for electroconductive titania (C792 printer,
50 ppm, 78° F./80% RH, 20000-30000 pages)

| | Small | | | | | |
|---|---|---|---|---|---|---|
| | silica | | | Q/M | DR M/A | TTU/ |
| | Type | ET- | | (μC/g) | (mg/cm²) | TtC |
| Toner ID | (% C) | 300W | Pages | (0K/EOT) | (0K/EOT) | (mg/pg) |
| Comp. | 1x R812 | Yes | 30000 | −48.8/−23.3 | 0.38/0.28 | 10.4/3.6 |
| Example 6 | (3.5% C) | | | | | |
| Comp. | 1x R504 | Yes | 20000 | −48.9/−28.4 | 0.41/0.37 | 17.6/10.5 |
| Example 7 | | | | | | |
| Example | 1x SS-1 | Yes | 25000 | −49.5/−22.4 | 0.39/0.42 | 11.8/3.6 |
| 6a | (3.6% C) | | | | | |
| Example | 1x SS-2 | Yes | 30000 | −45.2/−22.2 | 0.39/0.31 | 10.1/1.9 |
| 6b | (3.1% C) | | | | | |
| Example | 1x SS-3 | Yes | 30000 | −44.6/−17.7 | 0.31/0.37 | 10.9/3.2 |
| 6c | (2.9% C) | | | | | |
| Example | 1.5x SS-1 | No | 25000 | −54.5/−25.9 | 0.32/0.35 | 13.6/4.8 |
| 7a | (3.6% C) | | | | | |
| Example | 1.5x SS-2 | No | 30000 | −50.2/−25.7 | 0.31/0.34 | 11.3 /2.8 |
| 7b | (3.1% C) | | | | | |
| Example | 1.5x SS-3 | No | 25000 | −50.3/−29.5 | 0.31/0.31 | 10.8/2.1 |
| 7c | (2.9% C) | | | | | |

As shown in Table 4, Comp. Example 7 toner performed poorly compared to Comp. Example 6 toner. The toner to cleaner was about 10 mg/pg for Comp. Example 7 toner in comparison to about 3.6 mg/pg for Comp. Example 6 toner. However, the Example toners listed in Table 4 using the modified small silicas SS-1, SS-2 and SS-3 performed better than Comp. Example 6 and 7 toners. Example 7a through 7c toners used about 50% more of the small silicas SS-1, SS-2 and SS-3 to compensate for the elimination of the expensive electroconductive titania ET-300W. Examples 7b and 7c toners performed similar to Examples 6b and 6c toners. Examples 7b and 7c toners did not show any deleterious print quality defect and importantly still sustained the ability to lower waste toner.

Abbreviated testing was performed with a conventional or pulverized toner to compare this toner finished with the SS-2 small silica and compared to a control conventional toner with the R812 small silica. In this example, an 8 μm conventional toner was blended in the manner previously described. The base toner was prepared from polyester resin melt compounded with carbon black, polyethylene wax, iron oxide and a charge control agent.

The resulting toner had a Tg (1^{st} scan onset) of approximately 57° C. and was surface treated with a medium silica having a primary particle size of about 40 nm-60 nm, an acicular titania having a size of about 1.6 to 1.7 μm in length and about 130 nm in diameter, an electroconductive titania having a primary particle size of about 30 nm-60 nm, a metal soap such as zinc stearate as well as the small silica shown in Table 5. The toner usage test was performed on a Lexmark Model MS810 printer (70 ppm) in nominal laboratory conditions. Toner usage was determined in a special 2000 print run mode with no intended development (ie white pages) designed to accentuate the generation of Toner-to-Cleaner or waste toner (TtC).

TABLE 5
Evaluation of modified small silica with
a conventional or pulverized toner

| | Small | Q/M | DR M/A | |
|---|---|---|---|---|
| | Silica | (μC/g) | (mg/cm²) | TtC |
| Toner ID | Type | (0/2000 pg) | (0/2000 pg) | (mg/pg) |
| Comp. | R-812 | −21.4/−13.6 | 0.65/0.51 | 2.2 |
| Example 8 | | | | |
| Example 8 | SS-2 | −23.5/−15.4 | 0.65/0.55 | 2.0 |

It can be determined from Table 4 that the replacement of the small silica R-812 with SS-2 small silica resulted in a 9% reduction in waste toner or TtC. Therefore, it may be concluded that modifying the surface treatment in a small silica with a mixture of a non-amine based silane and an aminosilane, wherein the % carbon content of the surface treatment is no greater than 3.5% can help lower the waste toner in a system. The modified surface treated small silica using a non-amine based silane and an aminosilane may be used in in an extra particulate additive package in combination with a medium sized silica, a large silica, and various titanias. This non-amine based silane and an aminosilane modified small silica can be a useful surface additive for toners prepared via a milling or pulverization process or a chemical process. While the additives mentioned here are not exhaustive, for one skilled in the art, it may be appreciated that the concept may be extended to similar types of titania or silica, or mixtures thereof.

1. A method for preparing a conventional toner composition comprising the steps of:
providing a polyester resin;
mixing in a dry state the polyester resin with a carbon black pigment, a polyethylene wax, an iron oxide and a charge control agent to form a resin additive mixture;
melt mixing the resin additive mixture with a kneader wherein the carbon black pigment, the polyethylene wax, the iron oxide and the charge control agent additives are dispersed in a uniform matter;
cooling the resin additive mixture;
crushing and milling the cooled resin additive mixture in a fluidized air mill to form a milled toner having a desired particle size;
classifying the milled toner to remove fine particles;
adding an extra particulate additive package to the classified milled toner, wherein the extra particulate additive package includes:
(a) a small sized silica having a primary particle size of about of about 2 nm to about 20 nm, a surface treatment including an aminosilane and a non-amine silane, and a carbon content
(b) a medium sized silica having a primary particle size of about 40 nm-60 nm;
(c) an electroconductive titania having a primary particle size of about 30 nm-60 nm;
(d) an acicular titania having a size of about 1.6 to 1.7 mm in length and about 130 nm in diameter; and
(e) a metal soap.

2. The method of claim 1 wherein the aminosilane is aminopropysilane.

3. The method of claim 1 wherein the non-amino silane is hexamethydisilane.

4. The method of claim 1 wherein the carbon content of the small sized silica is 3.1%.

5. The method of claim 1, wherein the desired particle size of the milled toner is 8 mm.

6. The method of claim 1, wherein the medium sized fumed silica particles are treated with a surface treatment selected from the group consisting of hexamethyldisilazane and polydimethylsiloxane.

7. The method of claim 1, wherein the metal soap is zinc stearate.
